(19) United States
(12) Patent Application Publication
(10) Pub. No.: US 2025/0173544 A1
(43) Pub. Date: May 29, 2025

(54) METHOD AND APPARATUS FOR PERFORMING CONTEXT AWARENESS AND RESPONSE BASED ON MULTI-TURN DIALOGUE

(71) Applicant: ELECTRONICS AND TELECOMMUNICATIONS RESEARCH INSTITUTE, Daejeon (KR)

(72) Inventors: Minjung Lee, Daejeon (KR); Eun Jung Kwon, Daejeon (KR); Hyunho Park, Daejeon (KR); Sung Won Byon, Daejeon (KR)

(21) Appl. No.: 18/825,986

(22) Filed: Sep. 5, 2024

(30) Foreign Application Priority Data
Nov. 27, 2023 (KR) 10-2023-0166765

(51) Int. Cl. G06N 3/04

(52) U.S. Cl. CPC G06N 3/04

(57) ABSTRACT

The present disclosure relates to a method and apparatus for performing context awareness and response based on multi-turn dialogue. A method of performing a context awareness and a response based on a multi-turn dialogue according to an embodiment of the present disclosure may comprise: performing prediction on a context awareness based on a multi-turn dialogue, through an artificial intelligence (AI) model; calculating an uncertainty value for the prediction through the AI model; and providing a response to a user within the multi-turn dialogue, based on a result of the prediction and the uncertainty value.

### CROSS-REFERENCE TO RELATED APPLICATIONS

This application claims the benefit of earlier filing date and right of priority to Korean Application No. 10-2023-0166765, filed on Nov. 27, 2023, the contents of which are all hereby incorporated by reference herein in their entirety.

### TECHNICAL FIELD

The present disclosure relates to a method, apparatus, and artificial intelligence system for performing awareness and response a context of a multi-turn dialogue.

### BACKGROUND

Chatbots, AI speakers, etc. need to provide natural conversations with users while understanding the user's intentions and processing complex requests. In this case, a function that recognizes the situation/context based on a multi-turn dialogue rather than a single-turn dialogue is required.

However, users may not provide only the information that the system can properly respond. Therefore, it is necessary to develop a system that clearly recognizes the situation/context in which it cannot respond when incomplete/complex/insufficient information is input and clearly identifies the intention through additional inquiries.

### SUMMARY

The technical object of the present disclosure is a method and apparatus for performing awareness and response a situation/context based on a multi-turn dialogue with a user.

The technical objects to be achieved by the present disclosure are not limited to the above-described technical objects, and other technical objects which are not described herein will be clearly understood by those skilled in the pertinent art from the following description.

A method of performing a context awareness and a response based on a multi-turn dialogue according to an aspect of the present disclosure may comprise: performing prediction on a context awareness based on a multi-turn dialogue, through an artificial intelligence (AI) model; calculating an uncertainty value for the prediction through the AI model; and providing a response to a user within the multi-turn dialogue, based on a result of the prediction and the uncertainty value.

An apparatus of performing a context awareness and a response based on a multi-turn dialogue according to an additional aspect of the present disclosure may comprise at least one processor and at least one memory, and the processor may be configured to: perform prediction on a context awareness based on a multi-turn dialogue, through an artificial intelligence (AI) model; calculate an uncertainty value for the prediction through the AI model; and provide a response to a user within the multi-turn dialogue, based on a result of the prediction and the uncertainty value.

As one or more non-transitory computer readable medium storing one or more instructions according to an additional aspect of the present disclosure, the one or more instructions may be executed by one or more processors and control an apparatus for performing a context awareness and a response based on a multi-turn dialogue to: performe prediction on a context awareness based on a multi-turn dialogue, through an artificial intelligence (AI) model; calculate an uncertainty value for the prediction through the AI model; and provide a response to a user within the multi-turn dialogue, based on a result of the prediction and the uncertainty value.

In variable aspects of the present disclosure, the uncertainty value may include at least one of a first uncertainty value whose value increases in the case of a dialogue in which topics of the respondable context candidates are mixed, or a second uncertainty value whose value increases in the case of a dialogue in which topics of the respondable context candidates are not mixed.

Additionally, in variable aspects of the present disclosure, if the first uncertainty value is greater than a pre-configured criterion, the response may correspond to a feedback response for collecting additional information.

Additionally, in variable aspects of the present disclosure, if the second uncertainty value is greater than a pre-configured criterion, the response may correspond to a feedback response to convey to the user that the response corresponds to a context in which it is impossible to respond.

Additionally, in variable aspects of the present disclosure, if the first uncertainty value and the second uncertainty value are less than a pre-configured criterion, the provision of the response may be performed using a database in which context-dependent responses are stored or a generative language model in which context-dependent responses are trained.

Additionally, in variable aspects of the present disclosure, the response may be based on one or more of a sentence generation function or a text-to-speech (TTS) function.

Additionally, in variable aspects of the present disclosure, the AI model may correspond to a model trained to perform the prediction on the context awareness based on prediction of an evidence vector.

Additionally, in variable aspects of the present disclosure, the evidence vector may be produced based on 1) a result of applying dialogue augmentation and a pre-trained natural language model to the multi-turn dialogue and 2) an extra feature extracted from extra information other than the multi-turn dialogue.

According to the present disclosure, a method and apparatus for recognizing a context and responding based on a multi-turn dialogue with a user may be provided.

According to the present disclosure, Through the AI model, the user's intention/context may be recognized through a multi-turn dialogue and the uncertainty of the corresponding prediction may be provided. Based on this, there is a technical effect that can build a robust system and increase user satisfaction by improving the response to the user (i.e., user response) by considering the measured uncertainty.

Effects achievable by the present disclosure are not limited to the above-described effects, and other effects which are not described herein may be clearly understood by those skilled in the pertinent art from the following description.

### BRIEF DESCRIPTION OF THE DRAWINGS

FIG. 1 illustrates an overall system architecture diagram providing a multi-turn dialogue-based context awareness and response according to an embodiment of the present disclosure.

FIG. 2 illustrates a detailed structural diagram of a context awareness system (100) according to an embodiment of the present disclosure.

FIG. 3 illustrates an operational flowchart of a method for performing context awareness and response based on a multi-turn dialogue according to an embodiment of the present disclosure.

FIG. 4 is a block diagram illustrating a device according to an embodiment of the present disclosure.

### DETAILED DESCRIPTION

As the present disclosure may make various changes and have multiple embodiments, specific embodiments are illustrated in a drawing and are described in detail in a detailed description. But, it is not to limit the present disclosure to a specific embodiment, and should be understood as including all changes, equivalents and substitutes included in an idea and a technical scope of the present disclosure. A similar reference numeral in a drawing refers to a like or similar function across multiple aspects. A shape and a size, etc. of elements in a drawing may be exaggerated for a clearer description. A detailed description on exemplary embodiments described below refers to an accompanying drawing which shows a specific embodiment as an example. These embodiments are described in detail so that those skilled in the pertinent art can implement an embodiment. It should be understood that a variety of embodiments are different each other, but they do not need to be mutually exclusive. For example, a specific shape, structure and characteristic described herein may be implemented in other embodiment without departing from a scope and a spirit of the present disclosure in connection with an embodiment. In addition, it should be understood that a position or an arrangement of an individual element in each disclosed embodiment may be changed without departing from a scope and a spirit of an embodiment. Accordingly, a detailed description described below is not taken as a limited meaning and a scope of exemplary embodiments, if properly described, are limited only by an accompanying claim along with any scope equivalent to that claimed by those claims.

In the present disclosure, a term such as first, second, etc. may be used to describe a variety of elements, but the elements should not be limited by the terms. The terms are used only to distinguish one element from other element. For example, without getting out of a scope of a right of the present disclosure, a first element may be referred to as a second element and likewise, a second element may be also referred to as a first element. A term of and/or includes a combination of a plurality of relevant described items or any item of a plurality of relevant described items.

When an element in the present disclosure is referred to as being “connected” or “linked” to another element, it should be understood that it may be directly connected or linked to that another element, but there may be another element between them. Meanwhile, when an element is referred to as being “directly connected” or “directly linked” to another element, it should be understood that there is no another element between them.

As construction units shown in an embodiment of the present disclosure are independently shown to represent different characteristic functions, it does not mean that each construction unit is composed in a construction unit of separate hardware or one software. In other words, as each construction unit is included by being enumerated as each construction unit for convenience of a description, at least two construction units of each construction unit may be combined to form one construction unit or one construction unit may be divided into a plurality of construction units to perform a function, and an integrated embodiment and a separate embodiment of each construction unit are also included in a scope of a right of the present disclosure unless they are beyond the essence of the present disclosure.

A term used in the present disclosure is just used to describe a specific embodiment, and is not intended to limit the present disclosure. A singular expression, unless the context clearly indicates otherwise, includes a plural expression. In the present disclosure, it should be understood that a term such as “include” or “have”, etc. is just intended to designate the presence of a feature, a number, a step, an operation, an element, a part or a combination thereof described in the present specification, and it does not exclude in advance a possibility of presence or addition of one or more other features, numbers, steps, operations, elements, parts or their combinations. In other words, a description of “including” a specific configuration in the present disclosure does not exclude a configuration other than a corresponding configuration, and it means that an additional configuration may be included in a scope of a technical idea of the present disclosure or an embodiment of the present disclosure.

Some elements of the present disclosure are not a necessary element which performs an essential function in the present disclosure and may be an optional element for just improving performance. The present disclosure may be implemented by including only a construction unit which is necessary to implement essence of the present disclosure except for an element used just for performance improvement, and a structure including only a necessary element except for an optional element used just for performance improvement is also included in a scope of a right of the present disclosure.

Hereinafter, an embodiment of the present disclosure is described in detail by referring to a drawing. In describing an embodiment of the present specification, when it is determined that a detailed description on a relevant disclosed configuration or function may obscure a gist of the present specification, such a detailed description is omitted, and the same reference numeral is used for the same element in a drawing and an overlapping description on the same element is omitted.

The proposed method and apparatus in the present disclosure relate to a system that accurately recognizes a context and responds to it based on a multi-turn dialogue with a user.

Specifically, in the case of the proposed method and device in the present disclosure, the response to the user (i.e., user response) can be improved by recognizing the user's intention/situation/context through a multi-turn dialogue using an AI model, providing the uncertainty of the corresponding prediction, and considering the measured uncertainty.

Hereinafter, a method for providing a multi-turn dialogue-based context awareness and response proposed in the present disclosure is described through detailed drawings and examples.

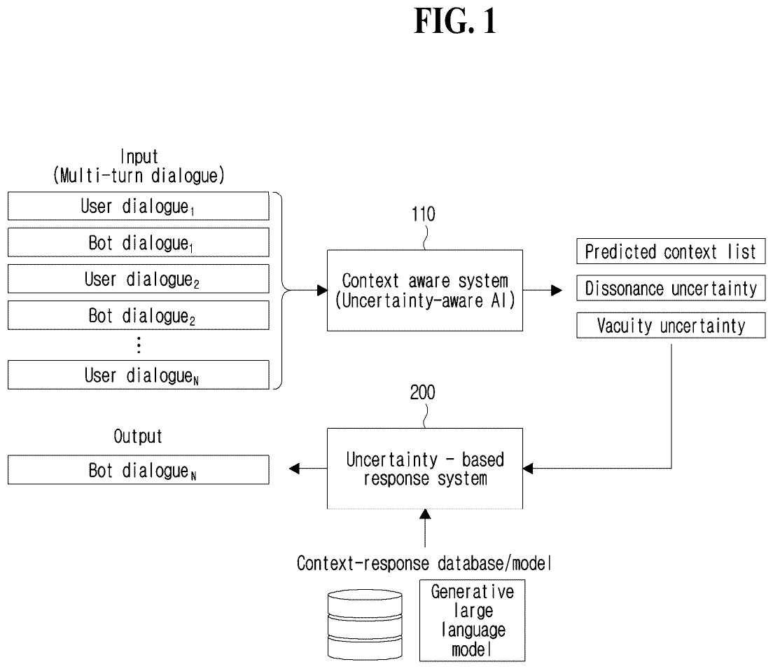

FIG. 1 illustrates an overall system architecture diagram providing a multi-turn dialogue-based context awareness and response according to an embodiment of the present disclosure.

Referring to FIG. 1, the overall system may be composed of a context awareness system (100) that performs context awareness based on a multi-turn dialogue and an uncertainty-based response system (200) that performs a response by utilizing the results and uncertainty of the context awareness.

First, the context awareness system (100) proposed in the present disclosure is described in detail.

The context awareness system (100) may correspond to a deep learning classification model capable of specifying uncertainty.

Conventional context awareness models may recognize/perceive a context/situation as one of a list of respondable context candidates.

In contrast, the context awareness model proposed in the present disclosure may measure not only the predicted value, i.e., the predicted context list, but also the uncertainty therefor. In this regard, the uncertainty that may be measured using the context awareness model may be of two types, i.e., Disssonance uncertainty and Vacuity uncertainty.

Specifically, for a multi-turn dialogue, Disssonance uncertainty may mean a type of uncertainty whose value increases when the topics of the respondable context candidates are mixed, and Vacuity uncertainty may mean a type of uncertainty whose value increases when the dialogue is about a topic that is outside the respondable context candidates.

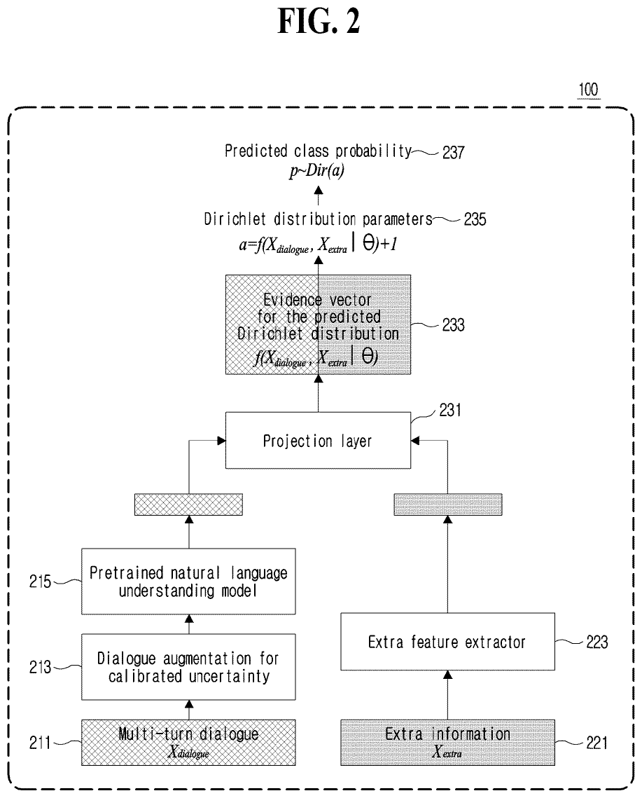

FIG. 2 illustrates a detailed structural diagram of a context awareness system (100) according to an embodiment of the present disclosure.

Referring to FIG. 2, an uncertainty-aware artificial intelligence (AI) model may be utilized in the context awareness system (100) proposed in the present disclosure.

The uncertainty-aware AI model may correspond to a model that uses a pre-trained language model for a multi-turn dialogue and extracts features from other available information to predict an evidence vector instead of a softmax probability value used in a general classification model.

The model utilized in the context awareness system (100) proposed in the above-described present disclosure may be trained using a loss function as expressed in the following Equation 1.

$$L ( f ( {x}_{i} \vert θ ) , {y}_{i} ) = \int \frac{{‖ {y}_{i} - {p}_{i} ‖}_{2}^{2}}{B ( {α}_{i} )} {\prod }_{j = 1}^{K} {p}_{ij}^{{α}_{ij} - 1} {dp}_{i} \qquad [ Equation 1 ]$$

In Equation 1, f represents a model, θ represents a model parameter, x represents an input, y represents an actual value, and B represents a beta distribution.

In this regard, a method of training and estimating the uncertainty of evidential neural networks may be used.

Additionally, augmentation (i.e., magnification) of a multi-turn dialogue may include calibrated uncertainty (e.g., dissonance uncertainty, vacuity uncertainty).

For example, the results generated by applying/using dialogue augmentation (213) for calibrated uncertainty for a multi-turn dialogue (X_{dialogue}) (211) and a pre-trained natural understanding model (215) may be input to the projection layer (231).

Additionally, information that may be used other than a multi-turn dialogue, i.e., extra features (223) extracted from extra information (Xₑₓₜᵣₐ) (221), may be input to the projection layer (231).

Afterwards, in the projection layer, based on the aforementioned results, an evidence vector for the predicted Dirichlet distribution may be generated. For example, the evidence vector may be expressed as f(X_{dialogue}, Xₑₓₜᵣₐ|θ).

Based on the evidence vector as described above, Dirichlet distribution parameter(s) (235) may be derived, and predicted class probability (237) may be derived based on this. For example, Dirichlet distribution parameter a may be expressed as f(X_{dialogue}, Xₑₓₜᵣₐ|θ)+1, and predicted class probability may be expressed as p˜Dir(α).

Next, the uncertainty-based response system (200) proposed in the present disclosure is specifically described.

If the size of the dissonance uncertainty value is large, the uncertainty-based response system (200) may perform a response to collect additional information so that the uncertainty is reduced. That is, in this case, a feedback response for the purpose of collecting additional information may be provided/delivered to the user.

If the size of the Vacuity uncertainty value is large, the uncertainty-based response system (200) may inform the user that the system is in a context where it may not respond. That is, in this case, a feedback response for the purpose of informing the user that the system is in a context where it may not respond may be provided/delivered to the user.

If both the Dissonance uncertainty value and the Vacuity uncertainty value are small, the uncertainty-based response system (200) may respond to the user using a database (DB) in which responses according to the context are stored and/or a generative language model (e.g., a generative large language model) in which responses are trained.

Additionally or alternatively, a response by the uncertainty-based response system (200) may include a sentence generation function and/or a text-to-speech (TTS) function.

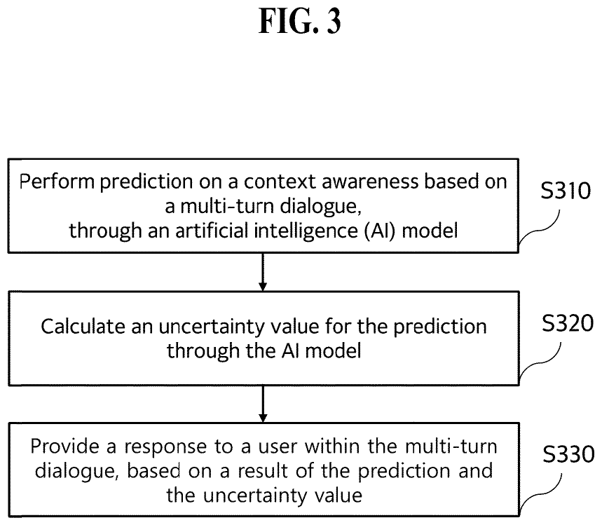

FIG. 3 illustrates an operational flowchart of a method for performing context awareness and response based on a multi-turn dialogue according to an embodiment of the present disclosure.

The procedure described in FIG. 3 may be performed by the context awareness system (100) and uncertainty-based response system (200) described above in the present disclosure.

First, through an artificial intelligence model, a prediction on context awareness may be performed based on a multi-turn dialogue (S310). For example, the artificial intelligence model may correspond to an uncertainty-aware AI model described with reference to FIG. 2.

Additionally, through the artificial intelligence model, an uncertainty value for the prediction in step S310 may be calculated (S320).

For example, the AI model may correspond to a model trained to perform a prediction on the context awareness based on the prediction of an evidence vector. In this regard, the evidence vector may be produced based on 1) the result of applying dialogue augmentation and a pre-trained natural language model to the multi-turn dialogue and 2) an extra feature extracted from extra information other than the multi-turn dialogue. In addition, the AI model may be trained using a loss function such as Equation 1 described above in the present disclosure.

Afterwards, based on the result of the prediction in step S310 and the uncertainty value in step S320, a response may be provided to the user in the multi-turn dialogue (S330). In this regard, the response may be based on one or more of the sentence generation function or the text-to-speech (TTS) function.

The uncertainty value produced in step S320 may include at least one of a first uncertainty value whose value increases in the case of a dialogue in which topics of the respondable context candidates are mixed, or a second uncertainty value whose value increases in the case of a dialogue in which topics of the respondable context candidates are not mixed. For example, the first uncertainty value may correspond to a Dissonance uncertainty value, and the second uncertainty value may correspond to a Vacuity uncertainty value.

For example, if the first uncertainty value is greater than a pre-configured criterion, the response may correspond to a feedback response for collecting additional information.

For another example, if the second uncertainty value is greater than a pre-configured criterion, the response may correspond to a feedback response to convey to the user that the response corresponds to a context in which it is impossible to respond.

For another example, if the first uncertainty value and the second uncertainty value are less than a pre-configured criterion, the provision of the response may be performed using a database in which context-dependent responses are stored or a generative language model in which context-dependent responses are trained.

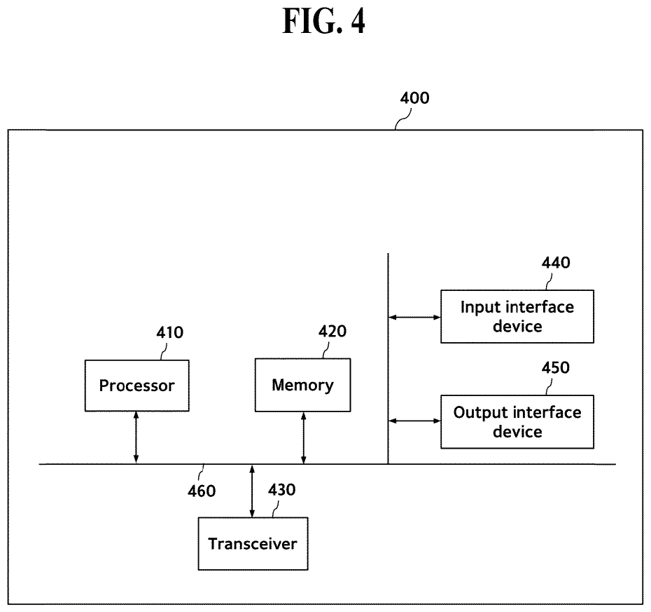

FIG. 4 is a block diagram illustrating an apparatus according to an embodiment of the present disclosure.

Referring to FIG. 4, device 400 may represent a device that implements a method of performing context awareness and response based on a multi-turn dialogue described in the present disclosure.

The device 400 may include at least one of a processor 410, a memory 420, a transceiver 430, an input interface device 440, and an output interface device 450. Each of the components may be connected by a common bus 460 to communicate with each other. In addition, each of the components may be connected through a separate interface or a separate bus centering on the processor 410 instead of the common bus 460.

The processor 410 may be implemented in various types such as an application processor (AP), a central processing unit (CPU), a graphic processing unit (GPU), etc., and may be any semiconductor device that executes a command stored in the memory 1020. The processor 410 may execute a program command stored in the memory 420. The processor 410 may be configured to implement a method and apparatus of performing context awareness and response based on a multi-turn dialogue described based on FIGS. 1 to 3 described above.

And/or, the processor 410 may store a program command for implementing at least one function for the corresponding modules in the memory 420 and may control the operation described based on FIGS. 1 to 3 to be performed.

The memory 420 may include various types of volatile or non-volatile storage media. For example, the memory 420 may include read-only memory (ROM) and random access memory (RAN). In an embodiment of the present disclosure, the memory 420 may be located inside or outside the processor 410, and the memory 420 may be connected to the processor 410 through various known means.

The transceiver 430 may perform a function of transmitting and receiving data processed/to be processed by the processor 410 with an external device and/or an external system.

The input interface device 440 is configured to provide data to the processor 410.

The output interface device 450 is configured to output data from the processor 410.

According to the present disclosure, a method and apparatus for performing context awareness and response based on a multi-turn dialogue with a user may be provided.

According to the present disclosure, the user's intention/situation/context may be recognized through a multi-turn dialogue using an artificial intelligence model, and the uncertainty of the corresponding prediction may be provided. Based on this, there is a technical effect of building a robust system and increasing user satisfaction by improving the response to the user (i.e., user response) by considering the measured uncertainty.

Specifically, according to the present disclosure, in relation to accurate intention and/or context understanding, there is a technical effect of accurately understanding and responding to incomplete or complex information of a user based on a multi-turn dialogue. In relation to robust response, there is a technical effect of accurately understanding an intention through additional questions and reliably recognizing a context in which a response is not possible, thereby minimizing errors. In relation to improving user satisfaction, there is a technical effect of reducing incorrect responses when uncertainty is utilized, so that users may obtain high satisfaction in a dialogue.

The components described in the example embodiments may be implemented by hardware components including, for example, at least one digital signal processor (DSP), a processor, a controller, an application-specific integrated circuit (ASIC), a programmable logic element, such as an FPGA, GPU other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers.

A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors. Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment.

Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

Accordingly, it is intended that this disclosure embrace all other substitutions, modifications and variations belong within the scope of the following claims.

What is claimed is:

1. A method of performing a context awareness and a response based on a multi-turn dialogue, the method comprising:
performing prediction on a context awareness based on a multi-turn dialogue, through an artificial intelligence (AI) model;
calculating an uncertainty value for the prediction through the AI model; and
providing a response to a user within the multi-turn dialogue, based on a result of the prediction and the uncertainty value.

2. The method of claim 1,
wherein the uncertainty value includes at least one of a first uncertainty value whose value increases in a case of a dialogue in which topics of respondable context candidates are mixed, or a second uncertainty value whose value increases in a case of a dialogue in which topics are outside respondable context candidates.

3. The method of claim 2,
wherein, if the first uncertainty value is greater than a pre-configured criterion, the response corresponds to a feedback response for collecting additional information.

4. The method of claim 2,
wherein, if the second uncertainty value is greater than a pre-configured criterion, the response corresponds to a feedback response to convey to the user that the response corresponds to a context in which it is impossible to respond.

5. The method of claim 2,
wherein, if the first uncertainty value and the second uncertainty value are less than a pre-configured criterion, the provision of the response is performed using a database in which context-dependent responses are stored or a generative language model in which context-dependent responses are trained.

6. The method of claim 1,
wherein the response is based on one or more of a sentence generation function or a text-to-speech (TTS) function.

7. The method of claim 1,
wherein the AI model corresponds to a model trained to perform the prediction on the context awareness based on prediction of an evidence vector.

8. The method of claim 7,
wherein the evidence vector is produced based on 1) a result of applying dialogue augmentation and a pre-trained natural language model to the multi-turn dialogue and 2) an extra feature extracted from extra information other than the multi-turn dialogue.

9. The method of claim 7,
wherein the AI model is trained using a loss function such as a following Equation, and
$$L ( f ( {x}_{i} \vert θ ) , {y}_{i} ) = \int \frac{{‖ {y}_{i} - {p}_{i} ‖}_{2}^{2}}{B ( {α}_{i} )} {\prod }_{j = 1}^{K} {p}_{ij}^{{α}_{ij} - 1} {dp}_{i} \qquad [ Equation ]$$
wherein, in the Equation, f represents a model, θ represents a model parameter, x represents an input, y represents an actual value, and B represents a beta distribution.

10. An apparatus of performing a context awareness and a response based on a multi-turn dialogue, the apparatus comprising:
at least one processor and at least one memory,
wherein the processor is configured to:
perform prediction on a context awareness based on a multi-turn dialogue, through an artificial intelligence (AI) model;
calculate an uncertainty value for the prediction through the AI model; and
provide a response to a user within the multi-turn dialogue, based on a result of the prediction and the uncertainty value.

11. The apparatus of claim 10,
wherein the uncertainty value includes at least one of a first uncertainty value whose value increases in a case of a dialogue in which topics of respondable context candidates are mixed, or a second uncertainty value whose value increases in a case of a dialogue in which topics are outside respondable context candidates.

12. The apparatus of claim 11,
wherein, if the first uncertainty value is greater than a pre-configured criterion, the response corresponds to a feedback response for collecting additional information.

13. The apparatus of claim 11,
wherein, if the second uncertainty value is greater than a pre-configured criterion, the response corresponds to a feedback response to convey to the user that the response corresponds to a context in which it is impossible to respond.

14. The apparatus of claim 11,
wherein, if the first uncertainty value and the second uncertainty value are less than a pre-configured criterion, the provision of the response is performed using a database in which context-dependent responses are stored or a generative language model in which context-dependent responses are trained.

15. The apparatus of claim 10,
wherein the response is based on one or more of a sentence generation function or a text-to-speech (TTS) function.

16. The apparatus of claim 10,
wherein the AI model corresponds to a model trained to perform the prediction on the context awareness based on prediction of an evidence vector.

17. The apparatus of claim 16,
wherein the evidence vector is produced based on 1) a result of applying dialogue augmentation and a pre-trained natural language model to the multi-turn dialogue and 2) an extra feature extracted from extra information other than the multi-turn dialogue.

18. The apparatus of claim 16,
wherein the AI model is trained using a loss function such as a following Equation, and
$$L ( f ( {x}_{i} \vert θ ) , {y}_{i} ) = \int \frac{{‖ {y}_{i} - {p}_{i} ‖}_{2}^{2}}{B ( {α}_{i} )} {\prod }_{j = 1}^{K} {p}_{ij}^{{α}_{ij} - 1} {dp}_{i} \qquad [ Equation ]$$
wherein, in the Equation, f represents a model, θ represents a model parameter, x represents an input, y represents an actual value, and B represents a beta distribution.

19. A non-transitory computer readable medium storing one or more instructions,
wherein the one or more instructions are executed by one or more processors and control an apparatus for performing a context awareness and a response based on a multi-turn dialogue to:
perform prediction on a context awareness based on a multi-turn dialogue, through an artificial intelligence (AI) model;
calculate an uncertainty value for the prediction through the AI model; and
provide a response to a user within the multi-turn dialogue, based on a result of the prediction and the uncertainty value.

20. The computer readable medium of claim 19,
wherein the uncertainty value includes at least one of a first uncertainty value whose value increases in a case of a dialogue in which topics of respondable context candidates are mixed, or a second uncertainty value whose value increases in a case of a dialogue in which topics are outside respondable context candidates.
